(19) United States
(12) Patent Application Publication
(10) Pub. No.: US 2025/0282417 A1
(43) Pub. Date: Sep. 11, 2025

(54) METHOD AND DEVICE FOR OPERATING A MOTOR VEHICLE

(71) Applicant: Robert Bosch GmbH, Stuttgart (DE)

(72) Inventor: Markus Beisswenger, Schwaebisch Hall (DE)

(21) Appl. No.: 19/064,779

(22) Filed: Feb. 27, 2025

(30) Foreign Application Priority Data
Mar. 6, 2024 (DE) 10 2024 202 107.5

(51) Int. Cl. B62D 6/00

(52) U.S. Cl. CPC B62D 6/003; B62D 6/006

(57) ABSTRACT

A method for operating a motor vehicle which has at least two wheel axles each having two wheels. At least the wheels of one of the wheel axles are pivotally mounted to set a requested steering angle, and these wheels are assigned at least one controllable steering actuator of a steering system which can be controlled to perform a cornering maneuver determined by the requested steering angle along a target curve path. The motor vehicle is monitored to determine whether it is accelerating or decelerating and, when acceleration or deceleration is detected during cornering, a current yaw moment of the motor vehicle is determined and, depending on the determined yaw moment, the at least one steering actuator is controlled to change the steering angle in order to follow the target curve path.

### CROSS REFERENCE

The present application claims the benefit under 35 U.S.C. § 119 of German Patent Application No. DE 10 2024 202 107.5 filed on Mar. 6, 2024, which is expressly incorporated herein by reference in its entirety.

### FIELD

The present invention relates to a method for operating a motor vehicle which has at least two wheel axles each having two wheels, wherein at least the wheels of one of the wheel axles are pivotally mounted in order to set a requested steering angle, and wherein these wheels are assigned at least one controllable steering actuator of a steering system which can be controlled to perform a cornering maneuver determined by the requested steering angle along a target curve path.

Furthermore, the present invention relates to a device for operating a motor vehicle which is designed as described above.

### BACKGROUND INFORMATION

Methods of the aforementioned general type are described in the related art. In order to guide or steer a motor vehicle along a predetermined target curve path, at least the wheels of one of the wheel axles are usually mounted so as to be pivotable about a vertical axis in order to set the steering angle required for the target curve path. In addition, it is conventional to monitor the wheels of a motor vehicle to determine whether they lock or are close to locking when braking is performed. An ESP system ensures that locking is generally prevented and that the cornering forces of the vehicle are maintained. When braking while cornering, in particular when high lateral accelerations occur, the normal forces acting on the wheels are distributed very unevenly between the wheels on the inside of the curve and the wheels on the outside of the curve. This means that the wheel on the inside of the curve begins to lock at a much lower braking torque than the wheel on the outside of the curve on the same wheel axle. Here too, however, the ESP system limits the braking torque on the wheels on the inside of the curve to prevent this locking.

With the increasing electrification of motor vehicles and increasing digitalization, the use of controllable, for example electromechanical steering actuators that are no longer mechanically coupled to the steering wheel of a motor vehicle, is also becoming more common, so that, for example, a steering angle specified by a driver by means of the steering wheel and, for example, a power steering system assigned to the steering wheel can be influenced by controlling such a steering actuator, or a steering angle requested by the driver by operating the steering wheel can be adjusted solely by the at least one steering actuator.

### SUMMARY

The method according to the present invention may have an advantage that the change in yaw moment caused by a one-sided braking torque limitation and acting on the motor vehicle is advantageously compensated for. According to an example embodiment of the present invention, the motor vehicle is monitored to determine whether it is accelerating or decelerating, and, when acceleration or deceleration is detected during cornering, a current yaw moment of the motor vehicle is determined and, depending on the determined yaw moment, the steering actuator is controlled to change the steering angle in order to follow the target curve path. According to the present invention, therefore, when it is detected that the vehicle is accelerating or decelerating when cornering, the current yaw moment is first determined and, depending on this determined yaw moment, the at least one controllable steering actuator is controlled so that the motor vehicle follows the target curve path despite the yaw moment changed by braking or acceleration or the resulting change in the slip angle on the wheel concerned. By intervening in the steering angle, the changing yaw moment is advantageously compensated for and the vehicle remains on the originally desired target curve path. This means that the vehicle's lateral and longitudinal guidance targets can be served or achieved for a much longer period when cornering with braking or acceleration. By actively compensating for the additional yaw moment introduced by the braking torque or the drive torque or the change in the yaw moment, the vehicle behaves neutrally in terms of transverse dynamics and the driver or, in particular, the autonomous driving function does not have to correct the steering angle. In addition, this allows for higher deceleration performance because no yaw moment limits need to be observed by limiting the possible longitudinal moments (acceleration and deceleration).

According to a preferred embodiment of the present invention, the steering angle is changed depending on a current slip angle and in particular a determined target slip angle of at least one of the wheels. Because the steering angle and the slip angle are not always identical, it is advantageous if the steering angle is changed depending on the current slip angle and the yaw moment. The slip angle, which depends on the vehicle speed and the steering angle, determines the actual curve or actual curve path of the motor vehicle. Knowing the slip angle, the compensation value can be advantageously determined in order to adjust the steering angle such that the actual curve path corresponds to the target curve path.

According to an example embodiment of the present invention, preferably, a compensation value for the slip angle is determined depending on the determined yaw moment and the requested steering angle, and the steering actuator is controlled depending on the compensation value. In particular, when the motor vehicle is steered by controlling at least one steering actuator alone, i.e. in particular when a steer-by-wire system is present which makes it impossible for the driver to reach mechanically from the steering wheel to the wheel to be steered, the advantageous method achieves that by providing a compensation value, the slip angle set by the steering actuator is advantageously controlled to compensate for the additional torque.

Furthermore, according to an example embodiment of the present invention, the compensation value is preferably determined using a vehicle and/or tire model. This advantageously reduces the computing power when determining the compensation value and increases the reaction speed of the method.

Furthermore, according to an example embodiment of the present invention, the yaw moment is preferably determined depending on the wheel torques acting on the wheels and a vehicle geometry of the motor vehicle. This allows a precise calculation of the yaw moment. In particular, the distances of the wheels to a center of gravity of the motor vehicle are taken into account and evaluated to determine the yaw moment acting on the motor vehicle as a whole. These distances of the vehicle geometry are preferably calculated, determined or measured beforehand and stored in a non-volatile memory of the motor vehicle, in particular a control unit of the motor vehicle; in particular, these distances are stored in the aforementioned vehicle model.

Particularly preferably, according to an example embodiment of the present invention, the current slip angle is determined depending on a differential friction coefficient which results from the yaw moment, at least one normal force acting on one of the wheels and the vehicle geometry.

Preferably, according to an example embodiment of the present invention, the compensation value is determined by means of an inverse steering model depending on a friction coefficient acting on at least one of the wheels. The inverse steering model ensures a simple determination of the compensation value depending on the at least one friction coefficient of at least one wheel.

A device according to the present invention includes a control device which is specially designed to perform the method according to the present invention when used as intended. This results in the advantages already mentioned above.

A motor vehicle according to the present invention includes the device according to the present invention. This results in the advantages already mentioned above.

Further advantages and preferred features and combinations of features result in particular from the above-described features and the rest of the disclosure herein. The present invention is explained in more detail below with reference to the figures.

### BRIEF DESCRIPTION OF THE DRAWINGS

FIG. 1 shows a motor vehicle in a simplified plan view, according to an example embodiment of the present invention.

FIG. 2 shows a diagram to explain an advantageous method for operating the motor vehicle, according to an example embodiment of the present invention.

### DETAILED DESCRIPTION OF EXAMPLE EMBODIMENTS

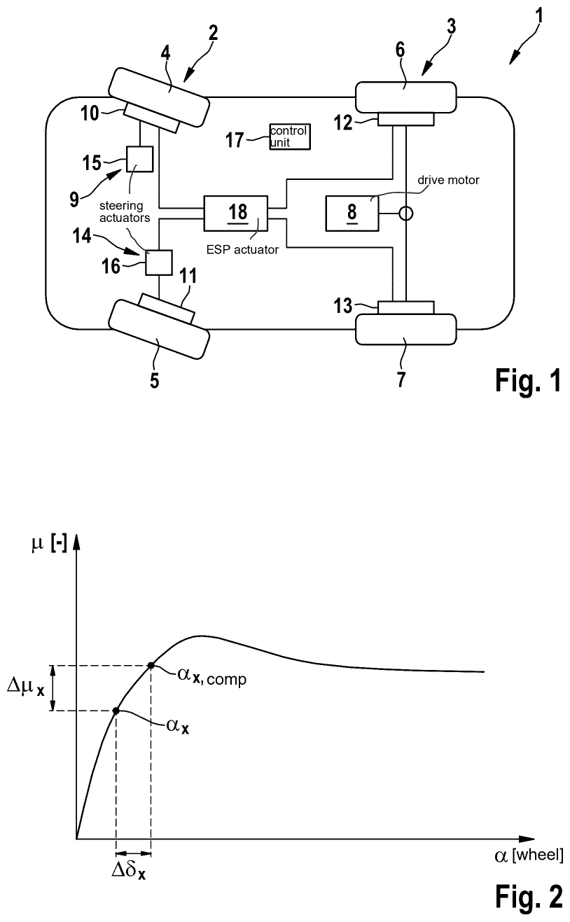

FIG. 1 shows a simplified representation of the motor vehicle 1 which has two wheel axles 2 and 3, wherein wheel axle 2 has two wheels 4 and 5 and wheel axle 3 has two wheels 6 and 7. The motor vehicle 1 also has a drive motor 8 which is connected or connectable to the wheels of at least one of the wheel axles 2 and/or 3 in order to drive or accelerate and/or brake or decelerate the motor vehicle 1. According to the present embodiment, the drive motor 8 is coupled to the wheels 6, 7 of the wheel axle 3 located at the rear in the forward direction of travel, which in this respect represents the rear wheel axle. The drive motor 8 can be an internal combustion engine or an electric motor or an electric machine that can at least be operated as a motor.

Furthermore, the motor vehicle 1 has a braking system 9 having a plurality of wheel braking devices 10, 11, 12, 13, each of which is assigned to one of the wheels 4 to 7 and is designed as a friction brake. The braking system 9 is designed so that the wheel brakes 10 to 13 can be controlled and actuated individually. Optionally, the braking system 9 is also designed to control the drive machine 8 in a generator-like manner in order to generate a deceleration torque. The braking system 9 allows the motor vehicle 1 to be decelerated if necessary, in particular depending on a braking request from the driver.

In addition, the motor vehicle 1 has a steering system 14 having at least one or, as shown in the present embodiment, two controllable steering actuators 15, 16, each of which is assigned to a pivotally mounted wheel of at least one of the wheel axles 2, 3, such as the wheels 4 and 5 in the present embodiment. Each steering angle of the wheels 4, 5 can be individually adjusted or influenced by the steering actuators 15, 16. The steering actuators 15, 16 may be present in addition to a power steering system, or as an alternative to a power steering system.

The braking system 9 also has, in particular, an ESP actuator 18 which, depending on a tendency of the wheels 4 to 7 to lock when carrying out a braking operation, limits the requested braking torque for each wheel individually in order to prevent locking. When cornering, the wheels 4, 5 are pivoted by the steering actuators 15, 16 depending on a steering angle requested by the driver or a driving system, so that the motor vehicle follows a target curve path corresponding to the requested steering angle. If a braking request is also detected during cornering and the ESP actuator reacts to reduce a braking torque on one of the wheels individually, this can lead to an unexpected or changed yaw moment acting on the motor vehicle 1.

Due to the high lateral accelerations that occur when braking during cornering, the normal forces Fₙ that act on each wheel 4 to 7 or through each wheel on a roadway are distributed very unevenly between the wheels on the inside of the curve, in this case wheels 4, 6, and the wheels on the outside of the curve, in this case 5, 7. This means that the braked wheel(s) 4, 6 on the inside of the curve begin to lock at much lower braking torques than the wheels 5, 7 on the outside of the curve. In this case, the ESP system or the ESP actuator reduces the braking torque on the inner wheels further than on the outer wheels, thereby changing the yaw moment acting on motor vehicle 1.

By means of the method described below, which is carried out in particular by a control unit 17 of the motor vehicle, this yaw moment is advantageously compensated for and taken into account while driving.

In particular, the control unit 17 continuously monitors the motor vehicle 1 to determine whether there is a braking request, an acceleration request and/or a steering request. In the event that the motor vehicle is both steered, i.e. cornering, and decelerated or accelerated, the control unit 17 determines the yaw moment M_{z} of the motor vehicle currently acting on the motor vehicle and controls the steering actuator(s) 14, 15 depending on the determined yaw moment in order to change the steering angle of the wheels 4, 5 such that the motor vehicle continues to follow the target curve path despite the changed yaw moment M2. To this end, the following procedure is used:

The yaw moment M_{z} that occurs or changes when cornering with acceleration or braking is advantageously converted into steering angle changes using vehicle and/or tire models, whereby the conversion can be carried out for both the front wheel axle 2 and the rear wheel axle 3. The conversion for the rear wheel axle 3 is useful if the wheels 6, 7 are also pivotally mounted.

The respective steering can be designed as axle steering or individual wheel steering, as shown in the present embodiment. The steering angle change is also superimposed by any bicycle steering request, i.e. the steering angle requested by a driver or driving system, and is taken into account, for example, via a differential steering angle interface. This results in direct compensation for the occurring yaw moment M_{z}, the change in which then has no effect on the lateral guidance of the vehicle. The yaw moment M_{z} occurring during cornering results in a simplified model, in particular neglecting the steering angle, from the wheel torques Mₓ acting on the wheels 4 to 7 (where x=4, 5, 6, 7) and the vehicle geometry as follows:

$${M}_{z} = \frac{{S}_{2}}{2 {r}_{2}} ( {M}_{5} - {M}_{4} ) + \frac{{S}_{3}}{2 {r}_{3}} ( {M}_{7} - {M}_{8} )$$

The parameters S_{y} represent the track width of each wheel axle 2, 3 (where y=2, 3) and r_{z} represents the curve radius of each wheel axle 2, 3 (where z=2, 3).

The wheel torques Mₓ correspond in particular to the sum of the measured or estimated actuator torques acting on the wheel, taking into account the potential limitation from the road friction coefficient and normal force:

$${M}_{x} = min ( \vert {M}_{brake , x} + {M}_{drive , x} \vert , {μ}_{rwheel} * {F}_{n , x} )$$

The calculated yaw moment M_{z} can be converted into a lateral force change for the rear and/or front wheel axle 2 in the case of axle steering or into a lateral force change for the individual wheels in the case of individual wheel steering and can be converted into a differential friction coefficient Δμ by means of the total normal forces acting on the wheels 4, 5, 6, 7. The following calculation then generally applies to a wheel x, where x=4, 5, 6, 7 and axle reference y=2, 3:

$$Δ {μ}_{x , y} = \frac{{M}_{Z}}{{l}_{x , y} * {F}_{nx , y}}$$

From the differential friction coefficient Δμ_{x,y}, preferably using a non-linear tire model and with knowledge of the state variable of the slip angle of each wheel x, the slip angle to be set is determined as the compensation value Xxx, comp (where x=4, 5, 6, 7) of the steering angle and thus the differential steering angle Δδₓ.

FIG. 2 shows the friction coefficient μ plotted over each wheel slip angle α. First, the friction coefficient utilization is determined at the current wheel slip angle:

μ(αₓ)=f(αₓ)

The wheel slip angle αₓ for each wheel x (where x=4, 5, 6, 7) results from

$${α}_{x} = {δ}_{x} - {tan}^{- 1} ( tan {β}_{x} + \frac{{l}_{x} \dot{ψ}}{v} )$$

where βₓ=slip angle, ψ=yaw rate, v=longitudinal speed of the motor vehicle 1 and 1x=distance of the wheel x (where x=4, 5, 6, 7) from the center of gravity of the motor vehicle 1. Since neither the slip angle β nor the yaw rate ψ change, the required differential steering angle results from the difference between α and α_{x,comp}:

$${α}_{x} - {α}_{x , comp} = {δ}_{x} - {tan}^{- 1} ( tan {β}_{x} + \frac{{l}_{x} \dot{ψ}}{v} ) - {δ}_{x , comp} + {tan}^{- 1} ( tan {β}_{x} + \frac{{l}_{x} \dot{ψ}}{v} ) = Δ {δ}_{x}$$

Preferably using an inverse model, the corrected wheel slip angle is then α_{x,comp} at the desired target friction coefficient utilization:

$${α}_{x , comp} = {f}^{- 1} ( μ ( {α}_{x} ) + Δ {μ}_{x}$$

The difference in the slip angles then results in the differential steering angle to be set:

$${Δδ}_{x} = {α}_{x , comp} - {α}_{x}$$

What is claimed is:

1. A method for operating a motor vehicle which has at least two wheel axles each having two wheels, wherein at least the wheels of one of the wheel axles are pivotally mounted in order to set a requested steering angle, and wherein pivotally mouding wheels are assigned at least one controllable steering actuator of a steering system which can be controlled to perform a cornering maneuver determined by the requested steering angle along a target curve path, the method comprising the following steps:
monitoring the motor vehicle to determine whether the motor vehicle is accelerating or decelerating; and
when acceleration or deceleration is detected, during cornering:
determining a current yaw moment of the motor vehicle, and
controlling, depending on the determined yaw moment, the at least one steering actuator to change the steering angle in order to follow the target curve path.

2. The method according to claim 1, wherein the steering angle is changed depending on a current slip angle of at least one of the wheels.

3. The method according to claim 2, wherein a compensation value for the slip angle is determined depending on the determined yaw moment and the requested steering angle, and the steering actuator is controlled depending on the compensation value.

4. The method according to claim 3, wherein the compensation value is determined using a vehicle and/or tire model.

5. The method according to claim 1, wherein the yaw moment is determined depending on wheel torques acting on the wheels and a vehicle geometry of the motor vehicle.

6. The method according to claim 1, wherein the compensation value is determined depending on the yaw moment and the current slip angle.

7. The method according to claim 1, wherein the compensation value is determined by means of an inverse steering model depending on a friction coefficient acting on at least one of the wheels.

8. A device for operating a motor vehicle, the motor vehicle having at least two wheel axles each having two wheels, wherein at least the wheels of one of the wheel axles are pivotally mounted in order to set a requested steering angle, and wherein the pivotally mounted wheels are assigned at least one controllable steering actuator of a steering system which can be controlled to perform a cornering maneuver determined by the requested steering angle along a target curve path, the device comprising:
a control device which is specially configured to:
monitor the motor vehicle to determine whether the motor vehicle is accelerating or decelerating; and
when acceleration or deceleration is detected, during cornering:
determine a current yaw moment of the motor vehicle, and
control, depending on the determined yaw moment, the at least one steering actuator to change the steering angle in order to follow the target curve path.

9. A motor vehicle which has at least two wheel axles each having two wheels, wherein at least the wheels of one of the wheel axles are pivotally mounted in order to set a requested steering angle, and wherein the pivotally mounted wheels are assigned at least one controllable steering actuator of a steering system which can be controlled to perform a cornering maneuver determined by the requested steering angle along a target curve path, the motor vehicle further comprising a device for operating the motor vehicle, the device including:
a control device which is specially configured to:
monitor the motor vehicle to determine whether the motor vehicle is accelerating or decelerating; and
when acceleration or deceleration is detected, during cornering:
determine a current yaw moment of the motor vehicle, and
control, depending on the determined yaw moment, the at least one steering actuator to change the steering angle in order to follow the target curve path.
